(19) United States
(12) Patent Application Publication
(10) Pub. No.: US 2013/0041818 A1
(43) Pub. Date: Feb. 14, 2013

(54) PROCESSING ON-LINE ACCOUNT REQUESTS

(71) Applicant: Reggie S. Whitley, Monroe, NC (US)

(72) Inventor: Reggie S. Whitley, Monroe, NC (US)

(73) Assignee: BANK OF AMERICA CORPORATION, Charlotte, NC (US)

(21) Appl. No.: 13/206,852

(22) Filed: Aug. 10, 2011

(51) Int. Cl. G06Q 40/00

(52) U.S. Cl. 705/42

(57) ABSTRACT

A request to perform an action is processed using an on-line account management system. A request is received from a first user to perform a first action associated with an account using an on-line account management system. A user database is accessed to determine a tier associated with the first user, wherein a first tier is associated with a low risk and a second tier is associated with a high risk. A processor determines whether to apply a rule in a rules database based on the first action and the tier. If the rule is applied, the processor determines whether to permit the first action according to the rule.

### TECHNICAL FIELD OF THE INVENTION

This invention relates generally to on-line account management and, more specifically, to processing on-line account requests.

### BACKGROUND

A user may have one or more accounts offered from an enterprise. In particular, a user may have various financial services and products from an enterprise. The enterprise may allow the user to perform various actions associated with the financial services and products. At times, the actions performed are ultimately deemed inappropriate or fraudulent.

### SUMMARY OF THE DISCLOSURE

In accordance with the present invention, disadvantages and problems associated with processing on-line account requests may be reduced or eliminated.

According to one embodiment of the present invention, a request to perform an action is processed using an on-line account management system. A request is received from a first user to perform a first action associated with an account using an on-line account management system. A user database is accessed to determine a tier associated with the first user, wherein a first tier is associated with a low risk and a second tier is associated with a high risk. A processor determines whether to apply a rule in a rules database based on the first action and the tier. If the rule is applied, the processor determines whether to permit the first action according to the rule.

Certain embodiments of the invention may provide one or more technical advantages. A technical advantage of one embodiment allows a system to process a request to perform an action associated with an account according to applicable rules. Another technical advantage of an embodiment reduces the possibility of actions associated with an account that would be inappropriate or fraudulent. For example, an account that has undergone recent profile changes could be restrained from being involved in a transaction that exceeds a certain monetary amount. Another technical advantage of an embodiment allows enterprises that service certain accounts to guard against risky transactions involving those accounts without interfacing with the account holder or other user. That is, enterprises may reduce inappropriate actions without direct involvement by the account holder.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an exemplary system that processes requests to perform an action using an on-line account management system.

FIG. 2 illustrates an exemplary embodiment of a rules engine that determines whether a requested action is permissible according to any applicable rules.

FIG. 3 illustrates an exemplary flow chart for processing a request to perform an action.

### DETAILED DESCRIPTION OF THE DRAWINGS

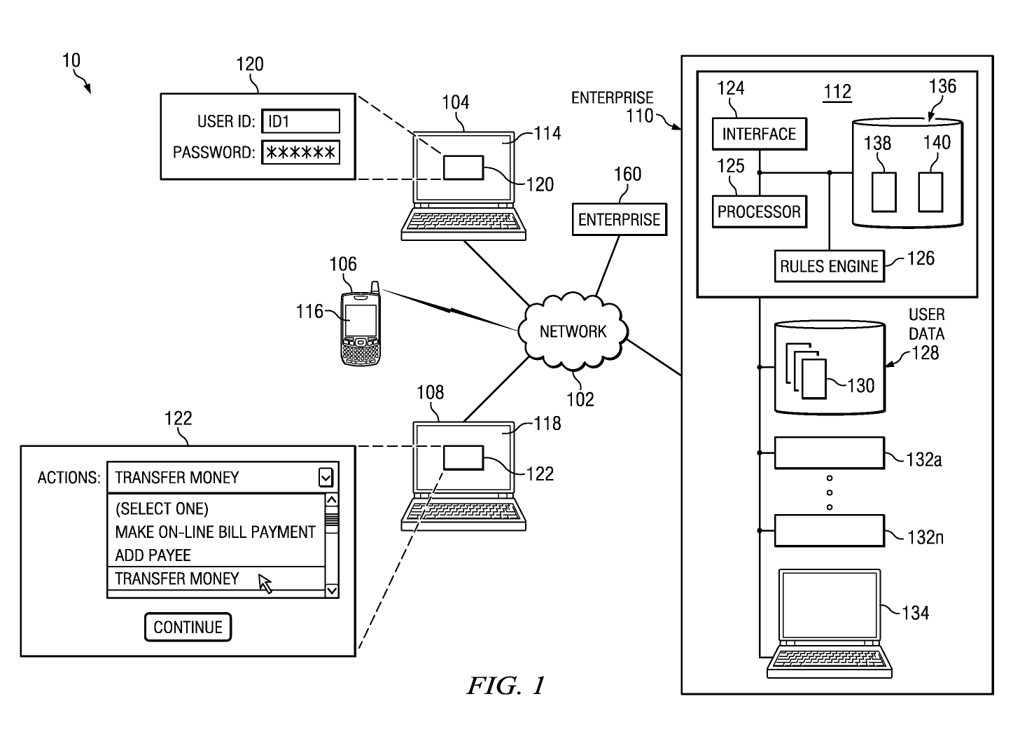

Embodiments of the present invention and its advantages are best understood by referring to FIGS. 1 through 3, like numerals being used for like and corresponding parts of the various drawings.

FIG. 1 illustrates a system 10 that processes requests to perform an action using an on-line account management system 112 of an enterprise 110. System 10 may consider activity occurring at or reported by a different enterprise 160 in determining how to process various requests. System 10 includes various access devices such as computer 104, wireless phone 106, and computer 108 that communicate with enterprises 110 and 160 over one or more networks 102. Users may use access devices 104, 106, and 108 to attempt to access on-line account management system 112 to perform various actions associated with one or more user accounts. Based on various rules, the components of enterprise 110 determine whether the attempted actions should be prohibited or permitted.

System 10 is operable to determine whether users should be permitted to perform an action associated with an account. The accounts may be one or more of a checking account, a savings account, a brokerage account, a loan account, an investment account, or any other suitable account. The actions may be requests to: initiate monetary transactions (such as wires, transfers, and/or bill payments), view information (such as balance information and/or information related to prior transactions), update data (such as address, phone, e-mail, etc.); receive monetary instruments (such as temporary or permanent debit/credit cards and/or new checks), add new accounts, add new payees, and/or perform any other actions. Components of system 10 may consider user data, transaction data, enterprise data, third-party data, applicable rules, and any other suitable information when determining whether the request should be permitted.

System 10 may include any number of suitable access devices that facilitate access to on-line account management system 110 such as computers (including, without limitation, personal computers, tablet computers, and laptops), wireless or cellular telephones, personal digital assistants, other handheld devices, or any other device suitable for communicating in system 10. Certain embodiments of system 10 include computer 104, wireless phone 106, and/or computer 108 as access devices. Each access device may be associated with certain identifying information such as an Internet Protocol (“IP”) address, which may be communicated to enterprise 110 using any suitable protocol. In certain embodiments, each access device may be associated with a device profile that indicates identifying information such as device name, location, platform, operating system, and/or any other suitable information.

In certain embodiments, computer 114, wireless phone 106, and computer 108 include graphical user interfaces (“GUIs”) 114, 116, and 118, respectively, which display information received from on-line account management systems 112 to a user. GUIs 114, 116, and 118 are generally operable to tailor and filter data entered by and presented to the user. GUIs 114, 116, and 118 may provide the user with an efficient and user-friendly presentation of information. For example, GUIs 114, 116, and 118 may display information regarding a checking account, a savings account, a brokerage account, a loan account, an investment account, or any other suitable account. GUIs 114, 116, and 118 may comprise a plurality of displays having interactive fields, pull-down lists, and buttons operated by the user. GUIs 114, 116, and 118 may include multiple levels of abstraction including groupings and boundaries. It should be understood that the term GUI may be used in the singular or in the plural to describe one or more GUIs and each of the displays of a particular GUI 114, 116, and/or 118.

GUIs 114, 116, and 118 may be displayed to a user using a web browser that allows a user of access devices 104, 106, and 108 to interact with a website, hosted by enterprise 110 for example, by transmitting information to and receiving information from the website. Suitable web browsers may include Microsoft Internet Explorer®, Mozilla Firefox®, Google Chrome™, Apple Safari™, or Opera®. In certain embodiments, GUIs 114, 116, and 118 may be displayed using an application natively installed on each of access devices 104, 106, and 108. For example, enterprise 110 may create and distribute a banking application designed for computers 104 and 108 and another banking application designed for wireless phone 106 that both operate outside of a web browser. A user may install the banking application on an access device and interact with the GUI provided by the banking application to communicate with and instruct on-line account management system 112 to perform certain actions. In certain embodiments, GUIs 114, 116, and 118 may be provided by a website or native application maintained by a third-party. For example, enterprise 160 may host a website or distribute a native application which enables access to accounts controlled by enterprise 110.

Using suitable access credentials, users of access devices may access any suitable account information, such as checking account information, savings account information, education savings information, credit card information, bill payment information, loan information, brokerage account information, investment account information, or any combination of the preceding. As one example, suitable access credentials may include an access identifier (or User ID) and password combination associated with appropriate privileges as specified by applicable restriction information. For example, in the illustrated embodiment, a user of computer 104 has entered an access identifier “ID 1” into a GUI control 120 of GUI 114 in an attempt to log on (or gain entry) to on-line account management system 112.

GUIs 114, 116, and 118 may allow a user to attempt to access on-line account management system 112 to perform certain actions associated with any suitable account such as the accounts named above. For example, a user may attempt an action associated with a checking account such as paying a bill on-line to a payee. More specifically, a GUI control, such as GUI control 122 of GUI 118, may provide several actions capable of being performed using on-line account management system 112. In the illustrated embodiment, a user of computer 108 has selected an action “Transfer Money.” On-line account management system 112 accesses suitable rules associated with the requested action and user information to determine whether the user is allowed to perform the selected action. Depending on the applicable rules, GUI 118 may inform the user that the user is not allowed to perform that action. Alternatively, GUI 118 may indicate that the user is allowed to perform that action, confirm successful completion of the action, indicate whether a problem occurred with the action unrelated to any applicable rules, or any suitable combination of the preceding.

Network 102 represents any suitable network that facilitates communication between the components of system 10, such as access devices 104, 106, and 108 as well as enterprise 110 and on-line account management system 112. Network 102 may include any interconnecting system capable of transmitting audio, video, signals, data, messages, or any combination of the preceding. Network 102 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Enterprise 110 may refer to a financial institution, such as a bank, brokerage house, or investment firm that communicates with access devices 104, 106, and 108 to provide access and perform actions associated with financial accounts, products, and services. Even though enterprise 110 is referred to as a financial institution, enterprise 110 represents any suitable type of entity in any suitable industry that allows a user to attempt to access an account on-line and perform actions associated with the account. Enterprise 110 may include various components operable to carry out actions in connection with user accounts. Certain embodiments of enterprise 110 include on-line account management system 112, a user database 128, functional modules 132, and administrative computer 134 communicatively coupled in any suitable manner.

On-line account management system 112 represents any suitable components that facilitate communication with access devices 104, 106, and 108 and allow users of those devices to attempt to perform certain actions associated with one or more accounts. On-line account management system 112 couples to any suitable components of enterprise 110 to determine whether the request should be allowed, and, if so, carry out the request.

For example, on-line account management system 112 may access stored user information to determine whether to allow a user to successfully access the system. An attempt to log in to on-line account management system 112 is an attempted action by a user of system 10. Thus, enterprise 110 may access applicable rules to determine whether the user should be allowed to log in. If applicable rules indicate that a user attempting to log on to the system is not allowed to do so, a message may be displayed to the user indicating such. A failed attempt to access on-line account management system 112 may trigger other rules or be recorded for consideration in determining whether to allow subsequent attempted actions.

On-line account management system 112 may include a network server, any suitable remote server, a mainframe, a host computer, a workstation, a web server, a personal computer, a file, server, or any other suitable device operable to communicate with access devices 104, 106, and 108 and process data. In some embodiments, on-line account management system 112 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of on-line account management system 112 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, on-line account management system 112 may include any suitable component that functions as a server.

In certain embodiments, on-line account management system 112 includes a network interface 124, a processor 125, a memory 136, and a rules engine 126.

Network interface 124 represents any suitable device operable to receive information from network 102, perform suitable processing of the information, communicate to other devices, or any combination of the preceding. For example, network interface 124 may receive a request to log on to on-line account management system 112 from a user of computer 104 using access identifier ID1. As another example, network interface 124 may receive a request to Transfer Money from a user of computer 108 and direct the request to the appropriate module of on-line account management system 112 or other modules of enterprise 110. Network interface 124 represents any port or connection, real or virtual, including any suitable hardware and/or software, including protocol conversion and data processing capabilities, to communicate through a LAN, WAN, or other communication systems that allows on-line account management system 112 to exchange information with network 102, computer 104, wireless phone 106, computer 108 or other components of system 10.

Memory 136 stores, either permanently or temporarily, data, operational software, or other information for processor 125. Memory 136 includes any one or a combination of volatile or nonvolatile local or remote devices suitable for storing information. For example, memory 136 may include random access memory (RAM), read only memory (ROM), magnetic storage devices, optical storage devices, or any other suitable information storage device or a combination of these devices. While illustrated as including particular modules, memory 136 may include any suitable information for use in the operation of on-line account management system 112.

In certain embodiments, memory 136 includes management software 138 and management data 140. Management software 138 represents any suitable set of instructions, logic, or code embodied in a non-transitory, computer readable medium and operable to facilitate the operation of on-line account management system 112. Management data 140 includes any suitable information regarding the management of on-line account management system 112. For example, management data 140 may include information regarding the management of a website associated with enterprise 110 and on-line account management system 112. Management data 140 may also include data sufficient to authenticate a user that attempts to log in to on-line account management system 112. For example, an IP address or a device profile of an access device 104, 106, or 108 may be compared to a list of permissible IP addresses or devices stored in management data 140.

Processor 125 communicatively couples to network interface 124 and memory 136. Processor 125 controls the operation and administration of on-line account management system 112 by processing information received from network interface 124 and memory 136. Processor 125 includes any hardware and/or software that operates to control and process information. For example, processor 125 executes management software 138 to control the operation of on-line account management system 112. Processor 125 may be a programmable logic device, a microcontroller, a microprocessor, any suitable processing device, or any suitable combination of the preceding.

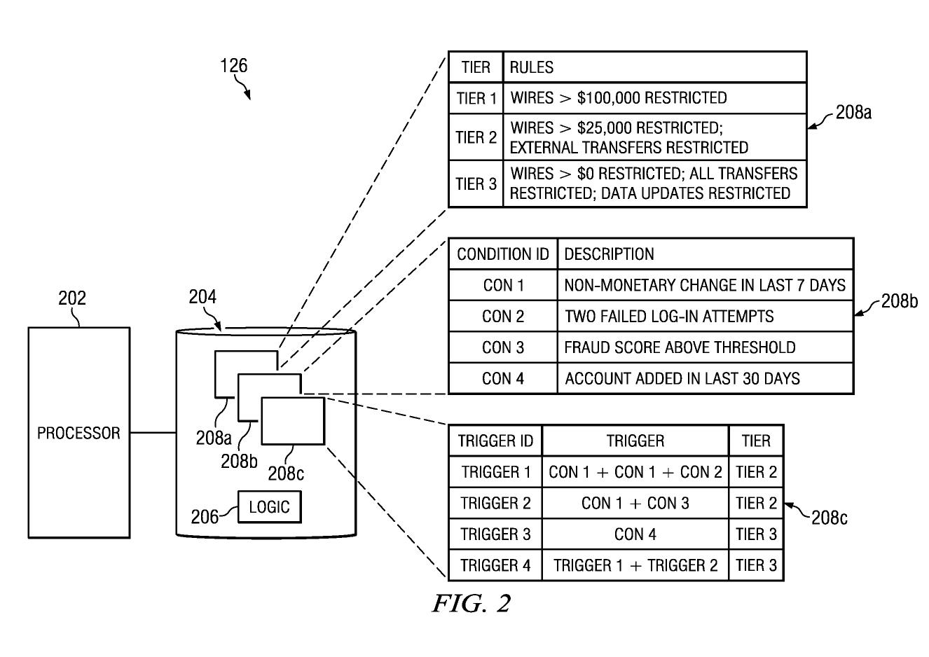

Rules engine 126 represents any suitable component that facilitates determining whether an attempted action is permissible according to applicable rules. Rules engine 126 may store applicable rules in a suitable component or access the rules from any suitable component of enterprise 110. Rules engine 126 may include a network server, any suitable remote server, a mainframe, a host computer, a workstation, a web server, a personal computer, a file, server, or any other suitable device operable to determine whether restriction information is associated with an access identifier. In some embodiments, rules engine 126 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of rules engine 126 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, rules engine 126 may include any suitable component that functions as a server. An exemplary embodiment of rules engine 126 is discussed below with respect to FIG. 2.

User database 128 stores, either permanently or temporarily, data, operational software, or other information for use by the components of enterprise 110. User database 128 includes any one or a combination of volatile or nonvolatile local or remote devices suitable for storing information. For example, user database 128 may include RAM, ROM, magnetic storage devices, optical storage devices, or any other suitable information storage device or a combination of these devices. While illustrated as including particular modules, user database 128 may include any suitable information for use in the operation of enterprise 110.

In certain embodiments, user database 128 includes user profiles 130. User profiles 130 may include any suitable user information associated with processing requests to perform actions. For example, user profiles 130 may include identifying information such as user's name, date of birth, address, phone number, and/or any other suitable identifying information. User profiles 130 may also include information related to a user's accounts such as account numbers, nicknames for accounts, account identifiers associated with an account, balance information of an account, limits of an account, disclaimers associated with an account, customer preferences, any other suitable data, or any suitable combination of the preceding. A user profile 130 may include information regarding all accounts maintained by the user at enterprise 110 and/or each user profile 130 may maintain information only for a subset of the user's accounts. If a user has been associated with a tier, the user's tier information may also be stored in user profiles 130. Exemplary tiers will be described in more detail below. User database 128 may be accessible from various modules of enterprise 110 for any suitable purpose. For example, on-line account management system 112 may access information in user database 128 to assist in authenticating a user attempting to log on to on-line account management system 112.

Enterprise 110 may include one or more functional modules 132 that facilitate particular functions, such as carrying out the actions deemed permissible by rules engine 126. For example, a functional module 132 that facilitates peer-to-peer transfers may transfer funds from one user's account to another user's account after rules engine 126 determines that a funds transfer between those users is permissible. As another example, another functional module 132 could perform interactive voice response (“IVR”) functions such as allowing a user to check balance information through telephone interaction. Functional modules 132 may authenticate users and provide balance information, for example, by accessing appropriate user profiles 130 in user database 128. The activity occurring through functional modules 132 may occur independent of on-line account management system 112 and may affect user information, such as the tier that a user is associated with as specified in user profile 130.

Functional modules 132 may include a network server, any suitable remote server, a mainframe, a host computer, a workstation, a web server, a personal computer, a file, server, or any other suitable device operable to determine whether restriction information is associated with an access identifier. In some embodiments, functional modules 132 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of functional modules 132 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, functional modules 132 may include any suitable component that functions as a server.

Administrative computer 134 represents any suitable components that facilitate establishment and/or modification of the configuration of any of the components of enterprise 110. An administrator may use administrative computer 134 to update the rules used by rules engine 126 to determine whether a requested action is permissible. For example, the administrator may review the circumstances surrounding user complaints of fraud or actions associated with their accounts initiated by dubious third-parties. Continuing with this example, suppose that one or more users complain that wire transfers that exceeded $100,000 and initiated after a recent change in a user's address information were fraudulent or otherwise inappropriate. Based on that information, the administrator may create a rule that specifies that wire transfers in excess of $100,000 from a user's account initiated after a recent change in the user's address information are not permitted using on-line account management system 112. The user may have to telephone a representative of enterprise 110 to initiate the wire transfer.

All or a portion of the rule creation/modification process can be done automatically by administrative computer 134 or any other suitable components of enterprise 110. For example, users may log their complaints about fraudulent or inappropriate transactions using on-line account management system 112.

Administrative computer 134 may process those complaints and analyze the circumstances leading up to the allegedly inappropriate transfers. Upon detecting certain commonalities in the circumstances, administrative computer 134 may create or modify a rule that restrains future transactions occurring under the same set of circumstances. For example, if three similar conditions occurred prior to a transaction later alleged to be inappropriate in over 1000 instances, administrative computer 134 could create a rule that restrains similar, subsequent transactions after the same three conditions occur.

Administrative computer 134 may comprise a network server, any suitable remote server, a mainframe, a host computer, a workstation, a web server, a personal computer, a file, server, or any other suitable device operable to determine whether restriction information is associated with an access identifier. In some embodiments, administrative computer 134 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 134 may be performed by any suitable combination of one or more servers or other components at one or more locations. In the embodiment where the modules are servers, the servers may be public or private servers, and each server may be a virtual or physical server. The server may include one or more servers at the same or at locations remote from one another. Also, administrative computer 134 may include any suitable component that functions as a server.

Enterprise 160 may refer to a financial institution, such as a bank, brokerage house, investment firm, or credit bureau that that provides information that may affect the rules applied by rules engine 126 of enterprise 110. Even though enterprise 160 is referred to as a financial institution, enterprise 160 represents any suitable type of entity in any suitable industry that has information that may relate to rules applied by rules engine 126. For example, as a credit bureau, enterprise 160 may communicate a fraud score associated with a user to any suitable component of enterprise 110, such as on-line account management system 112 or any suitable functional module 132. The fraud score may be stored in user profile 130. In this situation, one of the rules applied by rules engine 126 may indicate that certain actions should be restrained if the user's fraud score is above or below a certain threshold. Enterprise 160 may include any suitable hardware, software, or logic (including a processor) to carry out its reporting operations.

In an exemplary embodiment of operation of system 10, a user utilizes wireless phone 106 to access a website associated with enterprise 110 using GUI 116. The user enters access credentials comprising an access identifier and password on GUI 116, which are transmitted to enterprise 110 and on-line account management system 112 over network 102. The request to access on-line account management system 112 also comprises an IP address associated with wireless phone 116.

On-line account management system 112 receives the request through interface 124. Network interface 124 alerts processor 125 to an attempted access of on-line account management system 112. Processor 125 compares the access credentials provided in the log on request against the credentials associated with the access identifier in management data 140. Processor 125 finds a mis-match between the transmitted and stored credentials, resulting in a failed log on attempt. Processor 125 records the failed attempt in user profile 130, and on-line account management system 120 informs the user of wireless phone 116 of the failed attempt through GUI 116. The user attempts a second log on attempt, using appropriate credentials, resulting in a successful log on to on-line account management system 112. The user attempts to change address information associated with their user profile 130 using on-line account management system 112. On-line account management system 112 passes the request to rule engine 126. Finding no contrary rules, rules engine 126 informs on-line account management system 112 that the address change is permitted. On-line account management system 112 changes the address information stored in user profile 130.

Continuing with the example embodiment, the user requests a wire transfer of $15,000. On-line account management system 112 passes the request to rules engine 126 to determine whether the wire transfer should be permitted. Rules engine 126 determines that a rule exists that restrains wire transfers that exceed $10,000 after a recent, failed log-on attempt and a recent address change by the user. Given that those conditions are satisfied by this situation, rules engine 126 informs on-line account management system 112 that the wire transfer is not permitted. On-line account management system 112 informs the user of the failed wire transfer through GUI 116.

A component of the system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, rules engine 126 and/or user database 128 may be integrated directly into on-line account management system 112. In another example, a request to log on to on-line account management system 112 may include an access identifier but exclude a password. In this example, the authentication by password may not be necessary or may be performed outside of enterprise 110. In another example, system 10 may exclude GUIs 114, 116, and 118 such that requests to perform actions are initiated using a command line interface or other suitable interface.

In certain embodiments, rules engine 126 may determine applicable rules when a user attempts to log on to on-line account management system 112 and determine which actions are not permitted. In these embodiments, GUIs 114, 116, and 118 may automatically exclude options that the user is prohibited from performing as specified by rules applicable by the user. In certain embodiments, rules engine 126 may only access rules pertinent to the specific action that the user is attempting to perform at the time the action is requested. This embodiment may have the advantage of more efficient processing given that system 10 may have to perform processing functions only on as as-needed basis.

FIG. 2 illustrates an exemplary embodiment of rules engine 126 that facilitates determining whether an attempted action is permissible according to applicable rules. This exemplary embodiment comprises a processor 202 communicatively coupled to a memory 204.

Processor 202 communicatively couples to memory 204 and controls the operation and administration of rules engine 126 by processing received information and accessing rules database 208. Processor 202 includes any hardware and/or software that operates to control and process information. For example, processor 202 may execute logic 206 to control operation of rules engine 126. Processor 202 may be a programmable logic device, a microcontroller, a microprocessor, any suitable processing device, or any suitable combination of the preceding.

Memory 204 stores, either permanently or temporarily, data, operational software, or other information for processor 202. Memory 204 includes any one or a combination of volatile or nonvolatile local or remote devices suitable for storing information. For example, memory 204 may include RAM, ROM, magnetic storage devices, optical storage devices, or any other suitable information storage device or a combination of these devices. While illustrated as including particular modules, memory 204 may include any suitable information for use in the operation of rules engine 126.

Logic 206 represents any suitable set of instructions, software, or code embodied in a computer-readable storage and operable to facilitate the operation of rules engine 126. For example, logic 206 may include instructions that indicate that processor 202 should scan rules database 208 to determine which rules should apply to a specific user.

A tier may comprise a set of rules to apply to particular actions requested by a user. A tier may be designated according to a particular group of users with common characteristics such as geography, occupation, type of access device, risk group, or any other suitable category. A tier organization designated according to risk group may comprise a tier associated with user profiles 130 deemed to be low risk and another tier associated with user profiles 130 deemed to be high risk.

A table 208a of rules database 208 illustrates example rules associated with tiers designated according to risk group. User profiles 130 deemed to be low risk are associated with Tier 1. User profiles 130 deemed to be medium risk are associated with Tier 2. User profiles 130 deemed to be high risk are associated with Tier 3. For each tier, table 208a indicates which rules should be applied to requests associated with user profiles assigned to the tier. For example, for user profiles 130 assigned to Tier 1, wire transfers over $100,000 will not be permitted. For user profiles 130 assigned to Tier 2, wire transfers over $25,000 are not permitted. Also, external transfers to accounts controlled by a different enterprise are not permitted. For user profiles 130 assigned to Tier 3, all wires and transfers are prohibited. Additionally, non-monetary updates to user profiles such as changes to address, phone number, and/or e-mail are prohibited.

A table 208b of rules database 208 illustrates example conditions that may place a user profile 130 into a different tier. Conditions may include actions requested by the user or any other suitable information, such as a fraud score or the balance of an account. In this example, condition 1 includes non-monetary updates made within the last seven days. Condition 2 includes two failed log in attempts to on-line account management system 112. Condition 3 includes having a fraud score from a third-party credit bureau above a certain threshold. Condition 4 includes creating a new account with enterprise 110 within the last 30 days.

A table 208c of rules database 208 illustrates example triggers to move user profiles 130 into different tiers based on the conditions specified in table 208b. Trigger 1 specifies that if condition 1 occurs twice and condition 2 also occurs with respect a certain user profile 130, that user profile 130 should be associated with Tier 2. Trigger 2 specifies that if condition 1 and condition 3 occur with respect to a certain user profile 130, that user profile 130 should be associated with Tier 2. Trigger 3 specifies that if condition 4 occurs with respect to a user profile 130, that user profile 130 should be associated with Tier 3. Triggers may also be nested. For example, trigger 4 specifies that if triggers 1 and 2 are both satisfied with respect a user profile 130, that user profile should be associated with Tier 3.

In certain embodiments, if multiple triggers are satisfied for a certain user profile 130, that user profile 130 should be moved to the most risky tier for which the trigger conditions are satisfied. Table 208c may only specify upward tier movements (i.e., movements to a more risky tier) or may also specify downward movements (i.e., movements to a less risky tier). Alternatively, another table in user database 208 may specify conditions that specify downward movements to less risky tiers.

Tiers may also be assigned in any other suitable manner. For example, a representative from enterprise 110 may assign a user profile 128 to a specific tier. As another example, a newly created account may automatically be placed in a medium risk tier. As another example, a user may communicate directly with a representative of enterprise 110 to change tiers and/or may request a tier change through an access device using on-line account management system 112. As another example, an account moved to a risky tier may automatically be moved down to a less risky tier after a certain period of time, such as one week or 30 days. In this way, potentially inappropriate actions are restrained, and the user may never know or need to know that their user profile 130 underwent tier changes.

Modifications, additions, or omissions may be made to rules engine 126. For example, table 208a may include rules associated with any action such as paying on-line bills, viewing account information, logging in to on-line account management system 112, adding a payee, or any other suitable action. As another example, the rules written in table 208a may specify prohibitions (i.e., what cannot be done), permissions (i.e., what can be done), or any suitable combination of the preceding. Additionally, the structures in rules database 208 are depicted as tables 208a, 208b, and 208c. Rules database 208 may comprise any suitable data structure to represent rule and tier information. For example, tables 208a, 208b, and 208c may be combined into any suitable data structure in any suitable combination.

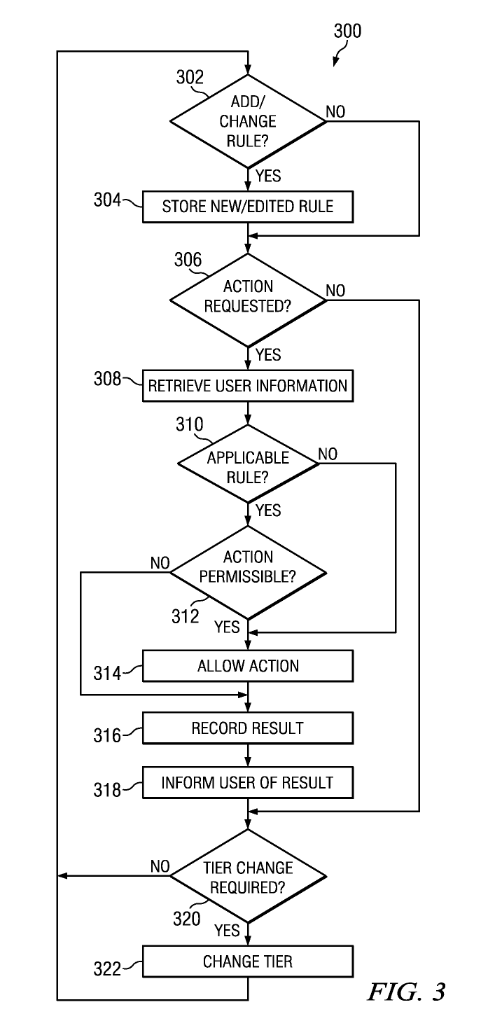

FIG. 3 illustrates an exemplary method 300 for processing a request to perform an action according to any applicable rules.

At step 302, it is determined whether any rules, conditions, and/or triggers should be added to or updated in rules database 208. This may happen, for example, after review of circumstances leading up to actions ultimately deemed fraudulent or inappropriate. If additions or modifications are desired, the new or updated rules, conditions, and/or triggers are added to rules database 208 at step 304. The rules may be added or updated automatically or with the assistance of an administrator.

At step 306, on-line account management system 112 determines whether a user has requested an action associated with an account. If so, user information from user profile 130 is passed to rules engine 126 along with information about the action requested at step 308. Based on the user information, which may include the tier and any other suitable information, rules engine 126 determines whether rules database 208 has an applicable rule at step 310. If an applicable rule exists, rules engine 126 applies the rule and determines at step 312 whether the requested action is permissible. Upon determining that the requested action is permissible or that there is no applicable rule, the action is executed at step 314. At step 316, on-line account management system 112 records the results relating to the request, which may indicate that the request was permitted, denied, or any other suitable information.

At step 318, the user may be informed of the result on a GUI of the access device that initiated the request. At step 320, on-line account management system 112 determines whether the user's profile should be associated with a different tier. This may happen because of conditions satisfied in rules database 208, passage of time, assignment by enterprise 110, direct request by the user, or for any other suitable reason. If a tier change is required, on-line account management system 112 associates the user's profile with a different tier at step 322. The method may repeat as necessary with step 302 to process additional requests and/or tier changes.

Modifications, additions, or omissions may be made to method 300 disclosed herein without departing from the scope of the invention. The methods may include more, fewer, or other steps. Additionally, steps may be performed in parallel or in any suitable order. For example, whether a user profile requires a tier change at step 320 may be determined before or in parallel with step 310.

Certain embodiments of the invention may provide one or more technical advantages. A technical advantage of one embodiment allows a system to process a request to perform an action associated with an account according to applicable rules. Another technical advantage of an embodiment reduces the possibility of actions associated with an account that would be inappropriate or fraudulent. For example, an account that has undergone recent profile changes could be restrained from being involved in a transaction that exceeds a certain monetary amount. Another technical advantage of an embodiment allows enterprises that service certain accounts to guard against risky transactions involving those accounts without interfacing with the account holder or other user. That is, enterprises may reduce inappropriate actions without direct involvement by the account holder.

Although the present invention has been described with several embodiments, a myriad of changes, variations, alterations, transformations, and modifications may be suggested to one skilled in the art, and it is intended that the present invention encompass such changes, variations, alterations, transformations, and modifications as falling within the scope of the appended claims.

1. An on-line account management system, comprising:
a network interface operable to receive a request from a first user to perform a first action associated with an account using an on-line account management system;
a processor communicatively coupled to the network interface and operable to:
access a user database to determine a tier associated with the first user, wherein a first tier is associated with a low risk and a second tier is associated with a high risk;
in response to receiving the request to perform the first action, determine whether to apply a rule in a rules database based on the first action and the tier; and
if the rule is applied, determine whether to permit the first action according to the rule.

2. The system of claim 1, wherein the processor is further operable to permit the first action if the first user is associated with the first tier and prohibit the first action if the first user is associated with the second tier.

3. The system of claim 1, wherein the processor is further operable to:
if the first user is associated with the second tier, determine that the rule should be applied, and
if the first user is not associated with the second tier, determine that the rule should not be applied.

4. The system of claim 1, wherein the processor is further operable to:
determine that the first user should be associated with a different tier based on the first action requested by the first user using the on-line account management system; and
associate the first user with the different tier in the user database.

5. The system of claim 1, wherein the processor is further operable to:
determine that the first user should be associated with a different tier after a time period elapses; and
associate the first user with the different tier in the user database.

6. The system of claim 1, wherein the processor is further operable to:
determine that the first user should be associated with a different tier based on activity that occurs outside of the on-line account management system; and
associate the first user with the different tier in the user database.

7. The system of claim 1, wherein the processor is further operable to:
monitor activity of a second user;
add a new rule to the rules database based at least in part on the activity of the second user; and
apply the new rule to a new action requested by the first user.

8. A method for processing requests to perform an action using an on-line account management system, comprising:
receiving a request from a first user to perform a first action associated with an account using an on-line account management system;
accessing a user database to determine a tier associated with the first user, wherein a first tier is associated with a low risk and a second tier is associated with a high risk;
in response to receiving the request to perform the first action, determining, by a processor, whether to apply a rule in a rules database based on the first action and the tier; and
determining, by the processor, whether to permit the first action according to the first action, the tier, and any applied rule.

9. The method of claim 8, wherein the first action is permitted if the first user is associated with the first tier and the first action is not permitted if the first user is associated with the second tier.

10. The method of claim 8, wherein determining whether to apply the rule further comprises:
if the first user is associated with the second tier, determining that the rule should be applied, and
if the first user is not associated with the second tier, determining that the rule should not be applied.

11. The method of claim 8, further comprising:
determining that the first user should be associated with a different tier based on the first action requested by the first user using the on-line account management system; and
associating the first user with the different tier in the user database.

12. The method of claim 8, further comprising:
determining that the first user should be associated with a different tier after a time period elapses; and
associating the first user with the different tier in the user database.

13. The method of claim 8, further comprising:
determining that the first user should be associated with a different tier based on activity that occurs outside of the on-line account management system; and
associating the first user with the different tier in the user database.

14. The method of claim 8, further comprising:
monitoring activity of a second user;
adding a new rule to the rules database based at least in part on the activity of the second user; and
applying the new rule to a new action requested by the first user.

15. A non-transitory computer readable medium comprising logic, the logic when executed by a processor, operable to:
receive a request from a first user to perform a first action associated with an account using an on-line account management system;
access a user database to determine a tier associated with the first user, wherein a first tier is associated with a low risk and a second tier is associated with a high risk;
in response to receiving the request to perform the first action, determine whether to apply a rule in a rules database based on the first action and the tier; and
if the rule is applied, determine whether to permit first action based on the rule.

16. The computer readable medium of claim 15, wherein the first action is permitted if the first user is associated with the first tier and the first action is not permitted if the first user is associated with the second tier.

17. The computer readable medium of claim 15, further comprising:
determining that the first user should be associated with a different tier based on the first action requested by the first user using the on-line account management system; and
associating the first user with the different tier in the user database.

18. The computer readable medium of claim 15, further comprising:
determining that the first user should be associated with a different tier after a time period elapses; and
associating the first user with the different tier in the user database.

19. The computer readable medium of claim 15, further comprising:
determining that the first user should be associated with a different tier based on activity that occurs outside of the on-line account management system; and
associating the first user with the different tier in the user database.

20. The computer readable medium of claim 15, further comprising:
monitoring activity of a second user;
adding a new rule to the rules database based at least in part on the activity of the second user; and
applying the new rule to a new action requested by the first user.
